(19) United States
(12) Patent Application Publication
(10) Pub. No.: US 2004/0112834 A1
(43) Pub. Date: Jun. 17, 2004

(54) Mineral ore slurry viscosity modification method

(76) Inventors: Libardo Perez, Morrisville, PA (US); David M Polizzotti, Yardley, PA (US); Ivy D Johnson, Lawrenceville, NJ (US)

Correspondence Address: Steven D Boyd, GE Betz Inc, 4636 Somerton Road, Trevose, PA, 19053-6783, US

(21) Appl. No.: 10/473,489

(22) PCT Filed: Apr. 3, 2002
(86) PCT No.: PCT/US02/10378

(51) Int. Cl. C02F 1/00

(52) U.S. Cl. 210/696

(57) ABSTRACT

A method of decreasing the viscosity of a mineral ore slurry is disclosed. The method comprises adding to a mineral ore slurry a viscosity modifying treatment such as copolymers of maleic anhydride and diisobutylene; copolymers of acrylic acid and allyl hydroxypropyl sulfonate ether, terpolymers of acrylic acid and 2-acrylamide-2-methypropane sulphonic acid salt and t-butyl acrylamide; copolymers of acrylic acid and polyethyleneglycol monoallyl ether sulfate; and copolymers of acrylic acid and 2-acrylamide-2-methypropane sulphonic acid salt; pentaphosphonates; polymethacrylates; and mixtures thereof to the mineral ore slurry.

### FIELD OF THE INVENTION

The present invention relates to a method for decreasing the viscosity of mineral ore slurries through the addition of a viscosity modifying treatment to the mineral ore slurry.

### BACKGROUND OF THE INVENTION

The viscosity of high solids mineral ore slurries (i.e. 50% solids or more) are often problematic in unit operations involving transport, pumping and agitation. For example, in the case of unit operations involving mixing, the viscosity of a mineral slurry increases as the weight percent of solids increases and the particle size decreases. Clays, especially those that swell, and other moieties present in the ore may exacerbate this effect. In most cases, mineral slurries exhibit non-Newtonian behaviors.

Mineral ore slurries are made up primarily of gangue or waste materials, ores and water. The gangue material makes up the largest component of mineral ore slurries. Gangue can be classified into recognized mineral classifications as follows: sulfides which include galena, pyrite, millerite and sphalerite; sulfates which include barite, celestite and gypsum; oxides which include goethite, hematitie, ilmenite, limonite, pyrolusite, rutile, and uranium minerals; silicates which include calamine-hemimorphite, feldspars, garnets, micas, olivine, perovskite, quartz, serprntine and clay minerals; carbonates which include calcite, dolomite, cerrusite and other non-iron carbonates; phosphate which include apatite, vivianite and pyromorphite; halides which include fluorite and halite; nitrates which include sodium nitrate etc.; and tungstates and molybdates. The precise composition of mineral ore slurry can vary greatly from site to site and even over time at one site due to changes in the ore body.

### SUMMARY OF THE INVENTION

It has been found that the difficulties associated with high solids mineral slurry viscosity can be overcome by the addition of selected viscosity modification agents to mineral ore slurries. It was discovered that the selection of the appropriate viscosity modification agent or agents can be based upon the type or types of gangue material present in the slurry. It has been found that efficacious viscosity modification agents include: copolymers of maleic anhydride and diisobutylene; copolymers of acrylic acid and allyl hydroxypropyl sulfonate ether; terpolymers of acrylic acid and 2-acrylamide-2-methypropane sulphonic acid salt and t-butyl acrylamide; copolymers of acrylic acid and polyethyleneglycol monoallyl ether sulfate; copolymers of acrylic acid and 2-acrylamide-2-methypropane sulphonic acid salt; pentaphosphonates; polymethacrylates; and mixtures thereof. Addition of one or more of these viscosity modification agents to a mineral ore slurry in an effective amount has been found to decrease the slurry viscosity. The reduction in slurry viscosity decreases the cost and problems related to transport, pumping and agitation of the viscous mineral ore slurry.

### DETAILED DESCRIPTION OF THE INVENTION

It was discovered that the addition of specific viscosity modifying agents selected from the group: copolymers of maleic anhydride and diisobutylene; copolymers of acrylic acid and allyl hydroxypropyl sulfonate ether; terpolymers of acrylic acid and 2-acrylamide-2-methypropane sulphonic acid salt and t-butyl acrylamide; copolymers of acrylic acid and polyethyleneglycol monoallyl ether sulfate; copolymers of acrylic acid and 2-acrylamide-2-methypropane sulphonic acid salt; pentaphosphonates; polymethacrylates; and mixtures thereof to mineral ore slurries in an appropriate amount will reduce the viscosity of the mineral ore slurry. Such viscosity reduction reduces problems present in the transportation, pumping and agitation of such slurries which are related to viscosity. The determination of the preferred viscosity modifier for a specific ore can be made based upon the type or types of gangue material present in the mineral ore slurry. The amount of treatment agent added to the mineral ore slurry will vary due to the variation in properties of different mineral ore slurries. In general, it has been found that the addition of from about 10 to 250 grams treatment per ton of mineral ore, preferably 20 to 175 grams per ton and most preferably 30 to 100 grams per ton will effectively reduce the viscosity of a mineral ore slurry by abut 10% or more. Routine rheological testing can be employed to determine the preferred treatment amount for a given sample of mineral ore slurry.

For mineral ore slurries containing silicate gangue materials, the preferred viscosity modifying treatment is selected from the group consisting of: copolymers of acrylic acid and allyl hydroxypropyl sulfonate ether; copolymers of maleic anhydride and diisobutylene; terpolymers of acrylic acid and 2-acrylamide-2-methypropane sulphonic acid salt and t-butyl acrylamide; pentaphosphonates; polymethacrylates; and mixtures thereof. For mineral ore slurries containing oxide gangue materials, the preferred viscosity modification treatment is selected from the group consisting of: copolymers of acrylic acid and allyl hydroxypropyl sulfonate ether; copolymers of acrylic acid and polyethyleneglycol monoallyl ether sulfate; and mixtures thereof. For mineral ore slurries containing carbonate minerals, the preferred viscosity modification treatment is selected form the group consisting of: copolymers of acrylic acid and 2-acrylamide-2-methypropane sulphonic acid salt; terpolymers of acrylic acid and 2-acrylamide-2-methypropane sulphonic acid salt and t-butyl acrylamide; pentaphosphonates; and mixtures thereof.

The invention is illustrated by the following examples, which are exemplary only and not intended to be limiting. All percentages, parts, etc. are by weight unless otherwise indicated.

### EXAMPLES

To demonstrate the effectiveness of these viscosity modification reagents, pulp rheology tests were conducted on samples of copper concentrate thickener underflow and copper tailing thickener feed provided by a North American copper mining operation. Viscosity measurements were taken on both pulps in the range of solids concentrations which would be fed to the pipelines for transport to the smelter or tailing pond (depending on the sample). A variety of agents were added to the pulps across a range of doses, in order to observe the effect of these products, if any, on the pulps' rheology. The range of pulps and agents tested are outlined and discussed in detail below.

After collection and correlation of Theological data from the copper concentrate and tailing was completed, results were compared to observe the magnitude, if any, of observed viscosity reduction which could be attributed to the various agents which were added to the test slurries. Any significant reduction in viscosity was assumed to result from the chemical additions since the pulps' solids contents were maintained at a constant level across directly comparable tests by adding the required amount of deionized water to compensate for lower volumetric additions of chemical in the lower dose tests.

Since test readings were taken at twelve (12) shear rates for each dose level of each chemical, it was helpful to simplify the data by averaging the viscosity reduction across all shear rates. The viscosity reduction at each shear rate is expressed as the negative percent change (so viscosity reductions are stated in positive percentages) in viscosity at the same shear rate between a sample with a given dosage of chemical, and a sample at the same solids content without any chemical additive. For convenience, the reduction in viscosity for a given dosage of a given agent will be defined as the average of the viscosity reductions (in percentage) across all tested shear rates.

Table 1 summarizes the agents tested.

TABLE 1

| Treatment | |
|---|---|
| Agent | Description |
| 1 | Maleic Anhydride/diisobutylene |
| 2 | Acrylic Acid/2-acrylamide-2-methypropane sulphonic acid |
| | salt/t- butyl acrylamide |
| 3 | Goodrite K-XP218 |
| 4 | Polymaleic Acid |
| 5 | 3:1 acrylic acid/allyl hydroxypropyl sulfonate ether (low MW) |
| 6 | Dicarboxylethyl N-alkyl C18 sulfosuccinate |
| 7 | acrylic acid/allyl hydroxyproply sulfonate ether (high MW) |
| 8 | Goodrite D-760N |
| 9 | Cytec Cyquest DP3(3) |
| 10 | Cytec Aerodry 1040 |
| 11 | Kerley Mining K1-704-3 |
| 12 | Polyacrylic Acid |
| 13 | Polyacrylic Acid |
| 14 | Fritz SC10 |
| 15 | Sulfonated Styrene Maleic Anhydride |
| 16 | Polyacrylic Acid |
| 17 | acrylic acid/allyl hydroxyproply sulfonate |
| | ether and polymaleic Acid |
| 18 | Pentaphosphonate |
| 19 | Polymethyacrylic Acid |
| 20 | dioctylsulfosuccinate |
| 21 | polyepoxysuccininc acid |
| 22 | ethyleneoxide-propyleneoxide copolymer |

In those cases where the chemistry is unknown, the commercial name of the product is provided. Treatment agents 1, 2, 5, 6, 7, 13, 15, 16, 17, 18, 19, 20, 21 and 22 are available from BetzDearborn Inc., Trevose PA. Treatments 3 and 8 are available from B.F. Goodrich. Treatments 9 and 10 are available from Cytec Industries. Treatment 11 is available from Kerley Mining and Treatment 14 is available from Fritz Industries.

A summary of the average viscosity reductions for both the concentrate and tailing pulps is shown below in Table 2.

TABLE 2

| | Average Reduction in Apparent | |
|---|---|---|
| | Viscosity (%) (,) for: | |
| | Copper | |
| | Concentrate | Tailing |
| | Pulp | Pulp Dosed |
| | Dosed with | with |
| Treatment | Additive at: | Additive at: |

| Agent | 30 g/MT | 60 g/MT | 30 g/MT | 60 g/MT |
|---|---|---|---|---|
| 1 | 17.5 | 27.8 | 14.5 | 19 |
| 2 | 11.9 | 28 | 12 | 18.5 |
| 14 | 12.2 | 20.3 | 8.7 | 8.7 |
| 3 | 9.4 | 16.6 | 2.6 | 1.6 |
| 4 | 3.1 | 10.2 | 5.5 | 7.2 |
| 5 | 3.1 | 10.2 | 5.5 | 13.5 |
| 7 | −3.5 | −9.6 | 0.4 | 1.7 |
| 19 | −17.4 | −16.3 | 5 | 6.2 |
| 6 | −1.4 | −7.7 | 4.1 | 8.2 |
| 7 | −26.6 | −43.5 | −10.2 | −28 |
| 8 | −59.4 | −89.9 | −12.7 | −25.9 |
| 9 | 10.8 | 18 | (not | (not |
| | | | tested) | tested) |
| 10 | 2.8 | 6.9 | (not | (not |
| | | | tested) | tested) |
| 11 | 1.9 | 0 | 4.6 | 6.9 |
| Reduction in apparent viscosity (stated in percent) is average of viscosity reductions at all shear rates tested (relative to control case at same solids content, pH, and temperature) for each condition. Negative values imply that the product addition | | | | |
| # actually caused the apparent viscosity to increase (on average) by the percentage shown. | | | | |

As the data in the Table 2 illustrates, treatment agents 1, 2, 14, 3, and 5 all consistently seemed to reduce the pulp viscosities by 10% or more at the level of 60 g/MT. Treatment agents 24, 25 and 6 were inconsistent, either only marginally reducing the viscosity (on the tailing pulp) or actually increasing it somewhat (on the concentrate pulp). Finally, treatment agents 7 and 8 both drastically increased the viscosities of both the concentrate and tailing pulps. For comparison purposes, three commercially available products were tested as well: Treatment agents 9, 10 and 11. These products are sometimes used as viscosity modifiers. Of the three, treatment agent 9 was the most effective on the concentrate for reducing the viscosity, although they all produced somewhat of a viscosity reduction.

It is clear from the data presented in this report that several of the treatment materials tested were effective in reducing the viscosity of a high solids mineral slurry. Indeed, in many cases, efficacy was demonstrated not only relative to controls, but also relative to other products commonly used in the industry to modify slurry viscosity. The composition of treatment agents 9, 10 and 11 are not known.

Study 2:

Additional testing was conducted which indicates that the addition of the treatment agents were effective in reducing the viscosity of high solids slurries of nickel laterites (containing predominately silica and oxide gangue), gold ores (containing predominately silicate gangue), and trona (a carbonate mineral). Several of these slurries contained clay components known to negatively impact (i.e. increase) mineral slurry viscosity. Examples of the effects discovered are summarized below. The data is reported as percent reduction in viscosity relative to an untreated control.

TABLE 3
Trona Ore Slurry Viscosity Study

% Reduction In Slurry Viscosity

| Treatment | g/ton | g/ton | g/ton | g/ton | Rank at |
|---|---|---|---|---|---|
| Agent | 50 | 100 | 175 | 200 | 100 g/ton |
| 2 | 26% | 23% | 27% | 27% | 1 |
| 13 | 17% | 23% | 34% | | 2 |
| 12 | 13% | 22% | 32% | 37% | 3 |
| 16 | 8% | 20% | 27% | | 4 |
| 15 | 6% | 15% | 30% | | 5 |
| 1 | 6% | 8% | 10% | 11% | 6 |
| 17 | 5% | 7% | 10% | 13% | 7 |
| 5 | 3% | 1% | 5% | | 8 |

TABLE 4
Ni-Laterite Slurry, 70% by weight slurry

% Reduction In Slurry Viscosity

| Treatment | g/ton | g/ton | g/ton | Rank at |
|---|---|---|---|---|
| Agent | 100 | 500 | 1,000 | 1000 g/ton |
| 13 | 19% | 83% | 92% | 1 |
| 12 | 25% | 72% | 88% | 2 |
| 1 | 19% | 64% | 88% | 3 |
| 2 | 16% | 44% | 72% | 4 |

TABLE 5
High Pyrite Containing Gold Ore Slurry

| | % Reduction In Slurry Viscosity | | | | | | | |
|---|---|---|---|---|---|---|---|---|
| Treatment | g/ton | g/ton | g/ton | g/ton | g/ton | g/ton | g/ton | Rank |
| Agent | 20 | 40 | 50 | 110 | 120 | 160 | 200 | at 50 g/ton |
| 5 | 17.3% | 25.7% | 35.1% | — | — | — | — | 1 |
| 18 | 17.3% | 26.1% | 34.0% | 47.9% | 52.2% | 57.9% | 63.3% | 2 |
| 19 | 19% | 24% | 28% | — | — | — | — | 3 |
| 5 | 13% | 22% | 28% | 32% | — | — | — | 4 |
| 2 | 8.6% | 14.2% | 23.9% | 35.1% | 40.0% | 46.8% | 53.0% | 5 |
| 15 | 13% | 22% | 22% | — | — | — | — | 6 |
| 14 | 1.9% | 10.0% | 17.8% | 29.8% | 34.2% | 41.3% | 46.2% | 7 |
| 1 | 15% | 27% | 16% | 29% | — | — | — | 8 |
| 3 | −1.0% | 14.1% | 15.7% | 25.0% | 26.9% | 36.9% | 42.9% | 9 |
| 12 | 12% | 23% | — | 42% | — | — | — | 10 |

TABLE 6
North American Gold Ore Slurry, 70% by weight slurry

| | % Reduction In Slurry Viscosity | | | | | |
|---|---|---|---|---|---|---|
| Treatment | g/ton | g/ton | g/ton | g/ton | g/ton | Rank |
| Agent | 20 | 40 | 60 | 80 | 100 | at 60 g/ton |
| 19 | 31.3% | 78.3% | 74.1% | 96.1% | | 1 |
| 13 | 37.6% | 53.2% | 63.0% | 51.1% | 97.4% | 2 |
| 16 | 28.0% | 45.5% | 60.7% | 66.0% | 97.7% | 3 |
| 12 | 35.8% | 55.3% | 58.6% | 44.1% | 96.8% | 4 |
| 2 | 36.0% | 57.5% | 54.7% | 97.9% | | 5 |
| 14 | 31.0% | 46.5% | 53.9% | 41.1% | 95.3% | 6 |
| 5 | 25.0% | 40.8% | 52.3% | 63.6% | 62.0% | 7 |
| 1 | 34.2% | 57.0% | 51.7% | 97.9% | | 8 |
| 1 | 19.1% | 38.3% | 48.1% | 57.4% | 57.8% | 9 |

The data shown in Tables 3-6 indicates that the chemistry most effective for the purpose of reducing slurry viscosity depends on the ore and the dose rate. For example, in the case of the Trona ore, AA/AMPS/t-butyl polymer provided more uniform viscosity reductions relative to the well known effects of polyacrylic acid.

In the case of the pyrite containing gold ore slurry, several chemistries were more effective than well known polyacrylic acid. Particularly noteworthy were the results of the pentaphosphonate and the AA/AMPS/t-butyl polymer.

In the case of the North American gold ore slurry, maleic anhydride/diisobutylene and AA/AMPS/t-butyl polymers were particularly effective at 80 g/ton relative to comparable dose rates of polyacrylic acid.

Based on the results of the laboratory data, a follow up test on the pyrite containing gold ore was conducted. The results of that test work is summarized below as Study 3.

Study 3:

When a fluid is subjected to external forces, it resists flow due to internal friction. Viscosity is the measure of this internal friction. Many types of viscosity modifiers are available, and choice depends on the particular circumstances. The chemical structure and molecular size are the most important elements of the molecular architecture of viscosity modifiers.

The major structural differences lie in the side groups, which differ both chemically and in size. These variations in chemical structure are responsible for various properties of viscosity modifiers.

Five treatment agents available from BetzDearborn Inc., Trevose, Pa. were tested in pyrite samples that were reconstituted to a RD (relative density) of 1.950 in the laboratory. Samples of the pyrite slurries without rheology modifier were used as the blanks for comparison. All tests were conducted in triplicate and the average of each of the three tests was used for the evaluation.

Samples of pyrite slurry were weighed, the density was rechecked and the time taken for a set volume of the slurry to flow through a funnel was recorded. Each of the five treatment agents were then tested in the same pyrite slurry and the times for the flow of the slurry were also recorded.

Different dose rates for each product were tested and the results are summarized below in Table 7.

TABLE 7

| Treatment | Dose rate | |
|---|---|---|
| Agent | (grams/solids T of ore) | Increase in flow |
| 1 | 400 | 28 percent |
| 1 | 300 | 23 percent |
| 5 | 400 | 18 percent |
| 20 | 400 | 12 percent |
| 21 | 400 | 12 percent |
| 22 | 400 | 11 percent |

Based on the results from the above, a further series of tests was run using treatment agent 1 on pyrite slurries with a RD in excess of 2.050. Pyrite slurry was prepared with an RD of 2.069 and a set of tests similar to those conducted above were performed. Again, triplicates were made and the averages used for relative comparisons. Table 8 summarizes the results.

TABLE 8

| | Dose rate | |
|---|---|---|
| | (grams/solids | |
| Treatment Agent | T of ore) | Increase in flow |
| 1 | 500 | 24 percent |
| 1 | 300 | 16 percent |
| 1 | 100 | 11 percent |

The results in Table 8 indicate that the treatment agent tested was capable of significantly modifying the rheology of the pyrite slurry even at an RD of 2.069.

It is not intended that the examples presented here should be construed to limit the invention, but rather they are presented to illustrate some specific embodiments of the invention. Various modifications and variations of the present invention can be made without departing from the scope of the appended claims.

What is claimed is:

1. A method of decreasing the viscosity of a mineral ore slurry comprising adding to a mineral ore slurry a viscosity modifying treatment selected from the group consisting of: copolymers of maleic anhydride and diisobutylene; copolymers of acrylic acid and allyl hydroxypropyl sulfonate ether; terpolymers of acrylic acid and 2-acrylamide-2-methypropane sulphonic acid salt and t-butyl acrylamide; copolymers of acrylic acid and polyethyleneglycol monoallyl ether sulfate; and copolymers of acrylic acid and 2-acrylamide-2-methypropane sulphonic acid salt; pentaphosphonates; polymethacrylates; and mixtures thereof.

2. The method of claim 1, wherein said viscosity modifying treatment is added to said mineral ore slurry in an amount sufficient to reduce the viscosity of said mineral ore slurry by about 10%.

3. The method of claim 2, wherein said viscosity modifying treatment is added to said mineral ore slurry in an amount of from about 10 to 250 grams per ton of mineral ore.

4. The method of claim 2, wherein said viscosity modifying treatment is added to said mineral ore slurry in an amount of from about 20 to 175 grams per ton of mineral ore.

5. The method of claim 2, wherein said viscosity modifying treatment is added to said mineral ore slurry in an amount of from about 30 to 100 grams per ton of mineral ore.

6. A method of decreasing the viscosity of a mineral ore slurry comprising silicate gangue materials comprising adding a viscosity modifying treatment selected from the group consisting of: copolymers of acrylic acid and allyl hydroxypropyl sulfonate ether; copolymers of maleic anhydride and diisobutylene; terpolymers of acrylic acid and 2-acrylamide-2-methypropane sulphonic acid salt and t-butyl acrylamide; pentaphosphonates; polymethacrylates; and mixtures thereof.

7. The method of claim 6, wherein said viscosity modifying treatment is added to said mineral ore slurry in an amount sufficient to reduce the viscosity of said mineral ore slurry by about 10%.

8. The method of claim 7, wherein said viscosity modifying treatment is added to said mineral ore slurry in an amount of from about 10 to 250 grams per ton of mineral ore.

9. The method of claim 7, wherein said viscosity modifying treatment is added to said mineral ore slurry in an amount of from about 20 to 175 grams per ton of mineral ore.

10. The method of claim 7, wherein said viscosity modifying treatment is added to said mineral ore slurry in an amount of from about 30 to 100 grams per ton of mineral ore.

11. A method of decreasing the viscosity of a mineral ore slurry comprising oxide gangue materials comprising adding a viscosity modifying treatment selected from the group consisting of: copolymers of acrylic acid and allyl hydroxylproply sulfonate ether; copolymers of acrylic acid and polyethyleneglycol monoallyl ether sulfate; and mixtures thereof.

12. The method of claim 11, wherein said viscosity modifying treatment is added to said mineral ore slurry in an amount sufficient to reduce the viscosity of said mineral ore slurry by about 10%.

13. The method of claim 12, wherein said viscosity modifying treatment is added to said mineral ore slurry in an amount of from about 10 to 250 grams per ton of mineral ore.

14. The method of claim 12, wherein said viscosity modifying treatment is added to said mineral ore slurry in an amount of from about 20 to 175 grams per ton of mineral ore.

15. The method of claim 12, wherein said viscosity modifying treatment is added to said mineral ore slurry in an amount of from about 30 to 100 grams per ton of mineral ore.

16. A method of decreasing the viscosity of a carbonate mineral ore slurry comprising adding a viscosity modifying treatment selected from the group consisting of: copolymers of acrylic acid and 2-acrylamide-2-methypropane sulphonic acid salt; terpolymers of acrylic acid and 2-acrylamide-2-methypropane sulphonic acid salt and t-butyl acrylamide; pentaphosphonates; and mixtures thereof.

17. The method of claim 16, wherein said viscosity modifying treatment is added to said mineral ore slurry in an amount sufficient to reduce the viscosity of said mineral ore slurry by about 10%.

18. The method of claim 17, wherein said viscosity modifying treatment is added to said mineral ore slurry in an amount of from about 10 to 250 grams per ton of mineral ore.

19. The method of claim 17, wherein said viscosity modifying treatment is added to said mineral ore slurry in an amount of from about 20 to 175 grams per ton of mineral ore.

20. The method of claim 17, wherein said viscosity modifying treatment is added to said mineral ore slurry in an amount of from about 30 to 100 grams per ton of mineral ore.
